(19) United States
(12) Patent Application Publication
(10) Pub. No.: US 2004/0170258 A1
(43) Pub. Date: Sep. 2, 2004

(54) Predictive dialing system and method

(76) Inventors: Mitch Levin, Lido Beach, NY (US); Amarish M Pathak, Clarksville, DE (US); Edward H Currie, Beechhurst, NY (US); Sonal R Pathak, East Patchogue, NY (US)

Correspondence Address: DILWORTH & BARRESE, LLP, 333 EARLE OVINGTON BLVD., UNIONDALE, NY, 11553, US

(21) Appl. No.: 10/491,200

(22) PCT Filed: Sep. 26, 2002
(86) PCT No.: PCT/US02/30694

Related U.S. Application Data
(60) Provisional application No. 60/324,956, filed on Sep. 26, 2001.

(51) Int. Cl. H04M 11/00; H04M 1/64

(52) U.S. Cl. 379/88.01; 379/88.16

(57) ABSTRACT

Predictive dialing system (100) and method is disclosed. Telephone numbers from a call list (FIG. 2) are automatically dialed and response received is analyzed. Message content in the response is detected using a speech recognizer and one or more follow-up actions based on the message content are performed. The follow-up actions may include rescheduling the call if the telephone number dialed is busy, not answering, or otherwise not working. Another follow-up action may include dynamically updating the list of telephone numbers in the call list, for example, if an operator message indicating that the phone number is no longer in service or that phone number has changed to a new number. Yet another follow-up action may include transferring the call to a live agent, for example, if a live greeting is received.

### CROSS-REFERENCE TO RELATED APPLICATIONS

This application claims the benefit of U.S. Provisional Application No. 60/324,956 filed on Sep. 26, 2001, entitled “Computer-Telephony Integration And Predictive Dialing System.”

### FIELD OF THE INVENTION

The present invention relates to computer telephony integration (“CTI”), and particularly to predictive dialing system and method, for example, in a call center using CTI.

### BACKGROUND OF THE INVENTION

Computer telephony integration (“CTI”) combines digital computer technology with conventional telephone systems, enabling computers to control various telephony functions such as making and receiving calls, providing facsimile, telephone directory services, caller identifications, and general graphic user interfaces associated with making telephone calls. This integration of telephone and computer systems has played a significant role in providing the ability to automate telephone systems with enhanced intelligence, and the ability to offer an array of different services, thus providing increased productivity.

Call centers, particularly, utilize CTI widely to automate inbound and outbound calls in conjunction with providing customer service, telemarketing, skip tracing, etc. To this end, many algorithms and methods including pacing algorithms each claiming more efficient automated calling systems in one aspect or another have been and are being developed. Accordingly, a system and method for providing more efficient and friendly call center services by predictive dialing is provided.

### SUMMARY OF THE INVENTION

There is provided an improved method and system for predictive dialing in CTI environment. The method in one aspect comprises receiving a list having one or more telephone numbers to dial, automatically dialing the telephone number, and analyzing a response tone from a receiver side. The analysis further includes detecting whether speech is in the response tone, and determining message content of the speech if speech is detected. One or more follow-up actions based on the analysis are then performed. The follow-up actions may include rescheduling the call if the telephone number dialed is busy, not answered, or otherwise not working. Another follow-up action may include updating the list of telephone numbers, for example, if an operator message indicating that a phone number is no longer in service or that phone number has changed to another number was received. Yet another follow-up action may include transferring the call to a live agent, for example, if a live greeting is received.

A system for predictive dialing in one aspect comprises a high level module and one or more low level modules running on, for example, one or more general purpose computer. The high level module performs application level functions such as maintaining a compiled list of telephone numbers and determining what follow-up actions to perform once the call is made and answered. The low level modules receive a list of telephone numbers to dial from the high level module and perform low level call dialing and signal receiving functions. The signals received are then analyzed for specific tones such as busy signals, or for specific voice messages such as operator recorded messages or live greetings. The low level modules also pass these messages to a speech recognizer for determining the content or type of the messages. The analyzed tone or determined messages are then passed back to the high level module for appropriate follow-up actions.

### BRIEF DESCRIPTION OF THE DRAWINGS

FIG. 1 is an example of an architectural diagram implementing an automatic call dialing system in one embodiment.

FIG. 2 is a flow diagram illustrating a predictive dialing method in one embodiment.

FIG. 3 is a flow diagram illustrating message processing in one embodiment.

FIG. 4 illustrates a screen showing an example of raw signals detected in the tone received.

FIG. 5 illustrates a screen showing an example of filtered signals after signal conditioning has been applied to the raw signals.

FIG. 6 illustrates a screen showing an example of signals ready for recognition.

### DETAILED DESCRIPTION

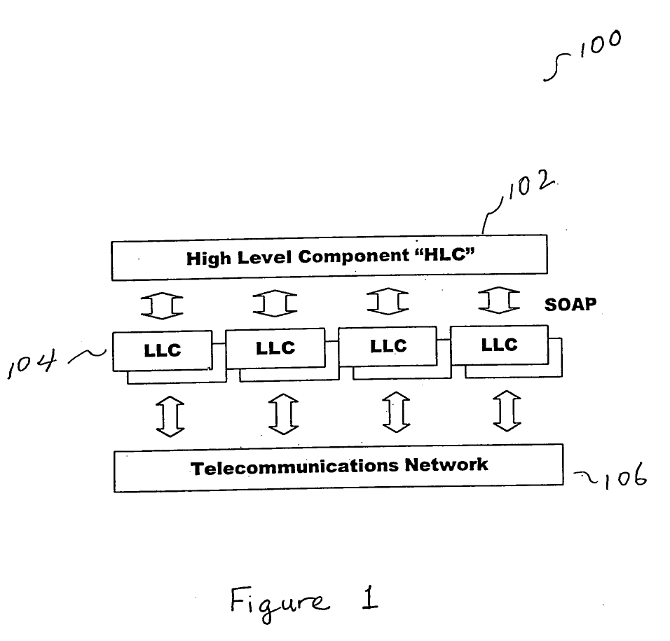

FIG. 1 is an example of an architectural diagram 100 illustrating a predictive dialing system in one embodiment. Generally, the system includes two components: one high level component (“HLC”) 102, and many low-level components (“LLC”s) 104. The HLC 102 and LLC 104 components may be implemented in software as well as hardware modules. Each LLC component 104 is responsible for performing low-level computer telephony integration (“CTI”) functions such as calling, tone detection, speech recognition, signal interpretation, etc. Each LLC 102 may run on its own process on one or more machines, and may be responsible for managing one port per process.

In one embodiment, the machines in which the HLC and LLCs reside, run Linux, for example, Redhat version 6.2, or a later version, a product of Redhat, Durham, N.C., with Dialogic's GlobalCall API, a product of Dialogic, an Intel Company, Waltham, Mass.

In another embodiment, the system may run on multiple machines in a cluster-based computing model, which exploits the aggregate power of networked collections of computers to provide significant parallel processing capabilities. In this embodiment, the predictive dialing system runs cluster-based, high performance workstations with microprocessors. Alternatively, the system may run on a widely available custom architecture such as massively parallel computers (“MPCs”), where memory and processing are distributed among a collection of processing nodes that communicate through a custom interconnection network, such as a hypercube, mesh, or torus network to provide high-performance. The cluster method, however, may provide more cost efficient and flexible system while at the same time providing the similar level of performance as the MPCs.

LLCs 104 collect and distribute signal and control information received from a telecommunications network 106 (such as ISDN) and are able to record audio data for performing signal processing and/or speech recognition either in real time or for processing at a later time. LLCs 104 may employ a speech recognizer that is based on one or more known algorithms for speech recognition. For example, an algorithm based on statistical models may be used, wherein each model represents a unit of sound or a phoneme that is to be recognized. Examples of known statistical models include a hidden Markov-model and audio data signature recognition models. Each model may be designed to use calculated statistics on the specific types of audio data being processed. Once the models are constructed, they are stored in a database and represent the vocabulary to be used for speech recognition.

Each LLC 104 component accepts call lists from the HLC 102 as application messages. After automatically placing calls on the call lists, LLC 104 signals to the controlling HLC 102 process the results of those calls. Call lists generally include a list of telephone numbers to dial.

Each LLC 104 component further may maintain a fixed input/output (“I/O”) buffer for outbound and inbound dialed calls. These calls are stored in process-local memory. For debugging, for example, each LLC 104 component may also maintain a log pertaining to signaling and maintenance of diagnostic information related to a port. For detailed logging, each LLC has the capability of serializing each Simple Object Access Protocol (“SOAP”) message sent or received to a storage medium.

The high level component, HLC 102, manages scheduling operations for the LLCs 104 and detects, processes, and routes communications events received from LLCs 104, external applications, and agents. The communications between the high-level 102 and low-level components 104 may be performed by using a lightweight data exchange protocol containing structured and typed information such as the SOAP, an XML-based protocol known to those skilled in the technological art. Thus, for example, an HLC 102 may exist on a single machine and may be responsible for controlling each LLC 104 on one or more machines by exchanging SOAP messages.

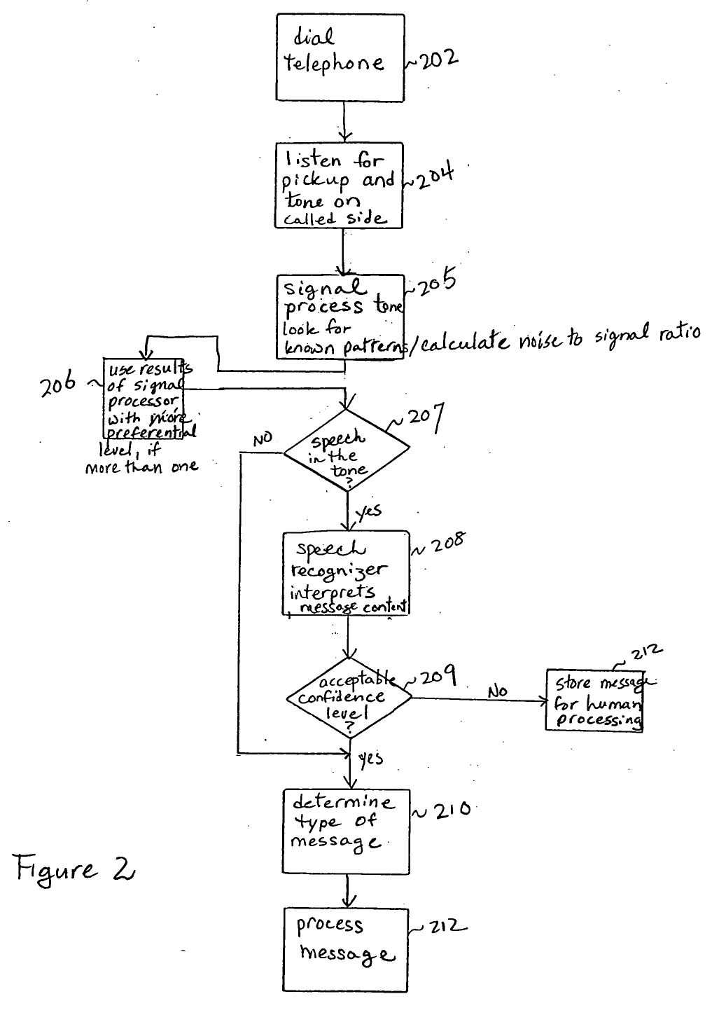

FIG. 2 is a flow diagram illustrating the predictive dialing method in one embodiment. In one aspect, the predictive dialing method enables outbound calling without having a live agent on the communications line, for example, a telephone line. At 202, a phone number on a call list is dialed and the activities from the called party or receiver's side is monitored. For example, a sound or tone when the phone is picked up is listened to at 204. Through tone detection, an operator intercept message may be detected, and once detected, the message may be recorded and passed onto a speech recognizer either as an audio stream or as a sound file. At 205, the tone is processed, for example, using a signal processing described in more detail below. At 206, a result of a signal processor having a preferential level is used. At 207, if speech is detected in the tone, the tone is passed to a speech recognizer. Otherwise, the processing continues to 210.

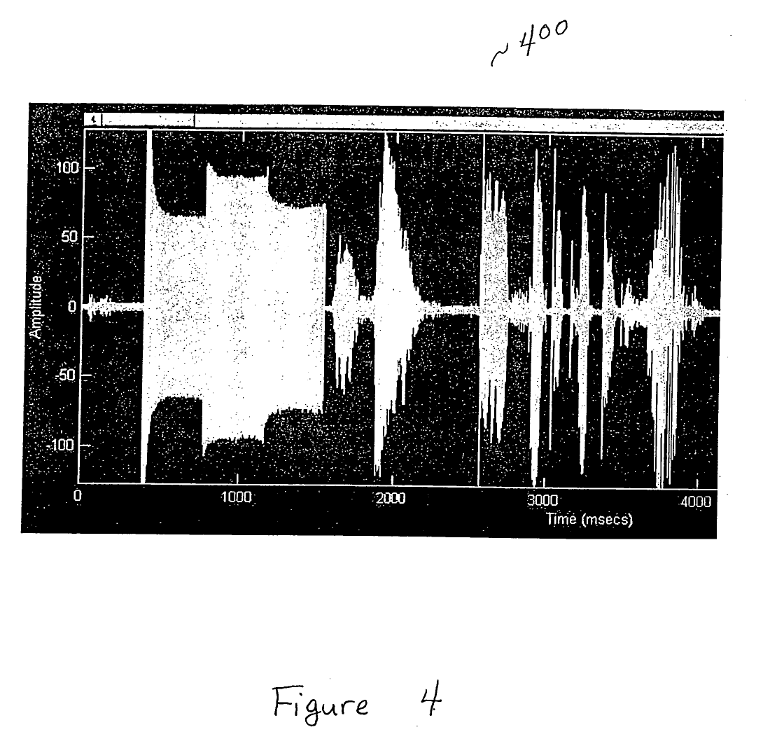

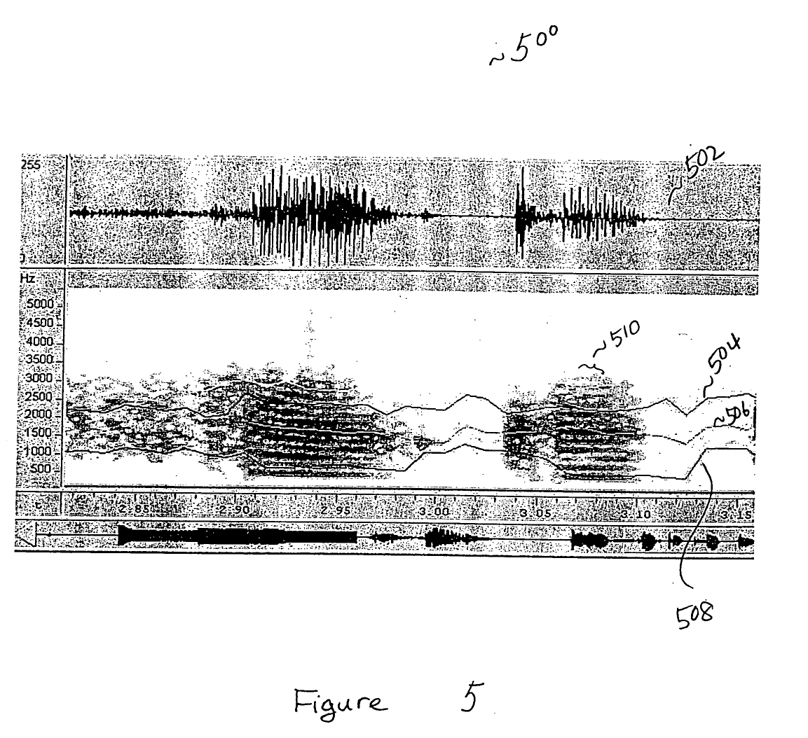

In one embodiment, the recorded message is first subjected to a signal conditioning process that, inter alia, removes noise and spurious signals. FIG. 4, for example, illustrates raw signals 400 received. These signals may be processed and conditioned by applying different effects, such as the Doppler, interpolation, noise reduction, and band pass effects. These effects are known to those skilled in the art, and therefore, will not be further described here. FIG. 5 illustrates waveform representations 500 of conditioned raw signals. The waveforms 502, 504, 506, 508, represent the received raw signals after the different effects are applied to them. For example, the waveform 504 may be a representation of the raw signals after the Doppler effect has been applied. As known to those skilled in the art, these different effects can improve the quality of signals by reducing noise 510. For example, Doppler effect can bend pitches of signals over a specific length to improve the quality of the signals. Further, the properties of the signals may be determined by applying these effects, and these properties may be used to determine preference or weighing factor for recognition algorithms used in the speech recognizer.

Referring back to FIG. 2, at 208, once the speech recognizer receives the audio data, it attempts to recognize individual words within a phrase or a set of words or phrases specified in a pre-defined vocabulary database. For example, the recognizer may distinguish speech from noise, compare utterances to those stored in a pre-defined vocabulary database, and label the utterances as matching or non-matching words or phrases.

At 209, it is determined whether the speech recognizer interpreted the message with a satisfactory or acceptable confidence level. For example, once an utterance or utterances are matched, a confidence level for the match is assessed by the speech recognizer. If a satisfactory confidence level is reached, then the message is deemed ‘properly matched’ and at 210 a type of message or content is determined. At 212, the message is processed accordingly. For example, the HLC may determine an appropriate action to be taken for the phone number, for example, to redial or to discontinue the dialing of the phone number. If an unsatisfactory confidence level is reached, at 212, the recorded message is archived and stored so that a human can listen to the recording, decipher the utterances, and apply or determine the appropriate action to be taken for the phone number.

In one embodiment, a voting scheme is employed that allows a confidence level to be determined based on the results of a number of recognition algorithms, e.g., signal signatures, parsing of the text, etc. A result of a recognition model that has the highest confidence level is then used to determine the contents of the message. The confidence level is a summation score of resulting voting scores of different recognition algorithms on various components in the recorded message. For example, given a list of candidate values to be voted on: c₁,c₂, . . . ,cₘ, a list of input voice data values S₁,S₂, . . . ,sₙ (these values are compared to candidate values) and a preference list per voter (i.e., list of algorithms by preference or weighting factor, which would be represented as pⱼ₁,pⱼ₂, . . . ,pₙₘ), a pair-wise voting scheme calculates the winner of each possible pairing for a given voting scheme and total the results for all schemes and achieve a confidence level.

A preference list for an algorithm is dependent on the properties determined by the system once the message is recorded and may, as a result, affect the summation score or confidence level. Identifying properties is called “pre-processing.” During pre-processing, the system may determine a property for a message such as “low audio quality” by employing a technique such as calculating a noise to signal ratio for the message. In this case, algorithms that perform better on “low audio quality” audio data may be used first, and may be found higher in the preference list so that the final summation score or confidence level may be higher as shown at 206.

In one aspect, a signal processing performed includes taking sets of frequencies and separating constituent partial components of sound, applying certain techniques to the signal, determining if known patterns exist within the signal and reporting a score based on matches or non-matches.

An example of a technique that may be applied to the signal is called the ‘Discriminant Approach’, which uses parametric functions such as the linear function below:

gᵢ(x)=wᵢ¹^{x+w}_{i0|} (1)

for some linear parameters:

wᵢε [symbol] ^{d} and wᵢ₀ε [symbol] (2)

to determine if a specific pattern discrimination exists between two or more naturally occurring groups or sets. Once a pattern (x) is specified, a classification system (\acute{ω}) assigns a pattern to a class \acute{ω}(x) to determine if a pattern belongs to a class of known pattern values.

Here is an illustration, for some adequately chosen thresholds T₁ and T₂.

$$\hat{ω} ( x ) = \{ \begin{matrix}\begin{matrix}{ω}_{1} \\ {ω}_{2}\end{matrix} \\ {ω}_{3}\end{matrix} \begin{matrix}\begin{matrix}when x < {T}_{1} , \\ when {T}_{1} \leq x \leq {T}_{2}\end{matrix} \\ when x \geq {T}_{2}\end{matrix} \qquad ( 3 )$$

The probability of error of a classification is denoted by Pₑ in:

$${P}_{e} = {\sum }_{i = 1}^{c} P ( \hat{ω} selects {ω}_{j} \neq {ω}_{i} \vert {ω}_{i} ) P ( {ω}_{i} ) \qquad ( 4 )$$

The key is that the more accurate classifications will be ones that minimize Pₑ the most.

Another example of a technique applied to the signal may be Fourier analysis, which is a method of defining periodic waveforms in terms of trigonometric functions. Many waveforms consist of energy at a fundamental frequency and also at harmonic frequencies (multiples of the fundamental). The relative proportions of energy in the fundamental and the harmonics determines the shape of the wave. The wave function (usually amplitude, frequency, or phase versus time) can be expressed as of a sum of sine and cosine functions called a Fourier series, uniquely defined by constants known as Fourier coefficients. If these coefficients are represented by a₀, a₁, a₂, a₃, . . . , aₙ, . . . and b₁, b₂, b₃, . . . , bₙ, . . . , then the Fourier series F(x), where x is an independent variable (usually time), has the following form:

F(x)=a₀/2+a₁cos x+b₁sin x+a₂cos2x+b₂sin 2x+ . . . +aₙ cos nx+bₙ sin nx+ (5)

In Fourier analysis, the objective is to calculate coefficients a₀, a₁, a₂, a₃, . . . , aₙ and b₁, b₂, b₃, . . . , bₙ up to the largest possible value of n. The greater the value of n (that is, the more terms in the series whose coefficients can be determined), the more accurate is the Fourier-series representation of the waveform.

Yet another example of a useful technique employed within the system is called “a wavelet.” A wavelet is a mathematical function useful in digital signal processing, whose principles are similar to those of Fourier analysis. In signal processing, wavelets make it possible to recover weak signals from noise. This proves useful especially in the processing of voice data, where voice data is processed with wavelets and can be “cleaned up” without deterring the details of the original source signal.

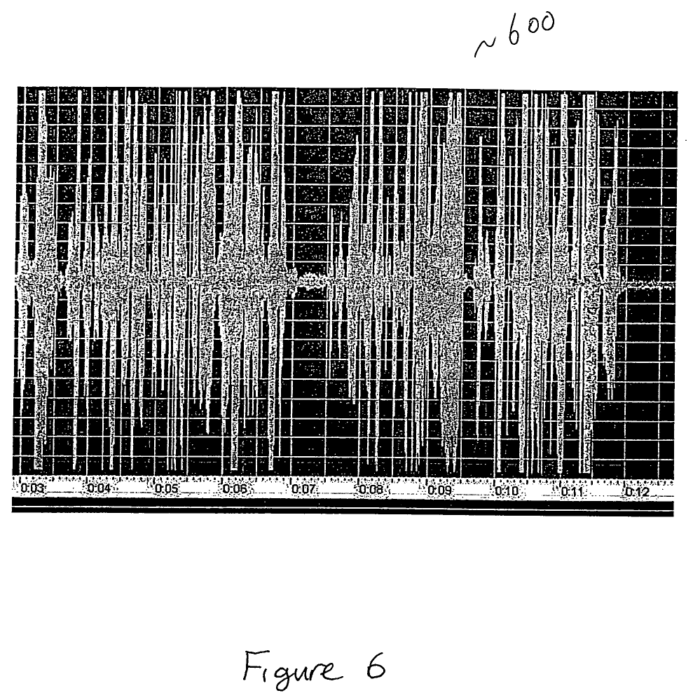

During the pre-processing phase, a list of peaks with their frequencies and amplitudes are stored. Thereafter, the incoming signal is broken into segments of N samples and these samples are then analyzed. One such method of analysis may include spectral analysis, where spectral templates are stored for common utterances found in stored common message types. Each new message may be spectrally compared with the stored ones and the closest match (if any) is reported. The underlying basis for this method is that there is some repeatability in the spectral properties of messages containing common utterances. FIG. 6 illustrates an example of a waveform 600 after having these techniques applied. If it is determined during the signal processing or speech recognition stage that the received signals are too poor for conditioning or processing, the signals are rejected. The rejected signals may be stored, for example, for human analysis.

Through the signal processing described above, speech and tones may be detected and differentiated from quiet line conditions. Further, the signal processing described above detects differences among the following conditions: line ringing but not being answered, line busy, problem completing a call (such as operator intercept), call answered by a human or answering machine, call answered by a facsimile machine or modem.

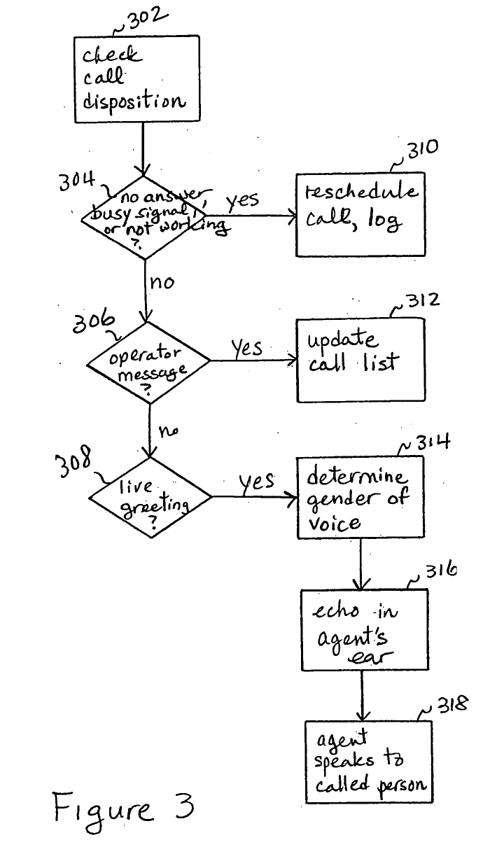

After the tone or message contents are analyzed, various high level processing steps are performed, for example, by the HLC, based on the analyzed message or tone. FIG. 3 is a flow diagram illustrating message processing in one embodiment. At 302, the call disposition, for example, tone or messages, is checked. At 304, if there was no answer, or busy signal was heard, or the phone was not working for any other reason, the call is rescheduled for a next time, and the action is logged at 310. At 306, if operator recorded messages were heard, the status of the phone number dialed may be updated according to the content of the message. For example, if a message deciphered or interpreted by the speech recognizer is “this number is no longer in service” or “the number has changed to . . . ,” the phone number may be deleted from the call list at 312 so that the same invalid number need not be redialed again. Further, if the message determined indicates a new phone number, the call list may be updated to include the new phone number. The dialed phone number, if no longer valid, may be set and/or logged as an invalid number.

Thus, there may be many different possible outcomes based on the contents in an operator message. Examples of these possible outcomes for a phone number based on message content include phone numbers that are permanently invalid or valid, temporarily valid or invalid, changed, not reachable, reachable by certain area codes, reachable by non-blocked numbers, reachable by dialing the phone number differently, busy, permanently disconnected, disconnected for non-payment (which may or may not become valid), etc.

At 308, if a greeting by a person is detected, for example, a live “hello” is detected, the system automatically transfers the call to an available agent. If a greeting from someone answering the telephone call is detected, the greeting is echoed to an available agent at 316 in a randomized voice. A randomized voice is voice data or utterances, which are computer generated on a periodic basis, but at time instants that are randomized with respect to other voice sources. This signals to the agent that there is a live person on the telephone line. The echoing of the greeting in the agent's ear yields a more natural conversation with the live person. In this way, agents are aware that the called party has voiced a greeting. At 318, an agent is enabled to speak with the called party.

In one aspect, at 314, a voice recognition algorithm is used to determine the gender of the voice that issued the greeting, allowing the agent to initiate conversation more naturally, for example, by beginning the conversation by saying “hello, sir”, or “hello, ma'am”. The gender determination may have been performed during the signal processing and speech recognition described with respect to FIG. 2.

The predictive dialing system places numerous calls simultaneously, checking each number, for example, for a live “hello” or for another call disposition. If the call is busy, no answer, not working, etc., the predictive dialing system either discards or reschedules the call, then dials another number. The predictive dialing system anticipates when the next agent will become available, and when the next “hello” will be detected. For example, the system analyzes call patterns based on data such as phone call lengths, available agents at certain intervals and percentage of unreachable phone numbers encountered for a particular interval. The system determines how many phone numbers should be dialed for the interval. The interval may not be fixed and may be any length of time such as 1 hour, multiple hours, 1 day, or multiple days. The analysis is configurable to allow more or less phone numbers to be dialed for a particular interval, and parameters such as the interval may be changed to allow pattern analysis of more or less data, as mentioned above, to achieve various levels of call anticipation estimates.

In one embodiment, if a greeting is not detected, the dialed phone number may be stored in an archival or other data bank, for example, to redial the phone number in the future and, for example, for reporting purposes.

The HLC (FIG. 1, 102) stores and manages criteria for scheduling jobs (calls) to be dialed. Examples of the criteria used in the pattern analysis and scheduling logic may include phone call lengths, the number of agents available, pattern of agent activity over certain intervals, the percentage of bad phone numbers in a dialing list, time-zones of phone numbers to be dialed, and the time the phone number was dialed. Further, the HLC 102 may also be configured for interactive voice response (IVR), voicemail, integrated Internet functions, etc. Incoming calls are answered by the system through a voice driven method, and allow callers to either leave a voicemail or speak to an agent. For example, the HLC 102 in one aspect handles such calls by forwarding the call to an agent. Further, an email request or message may be made to an agent to call back the caller.

HLC 102 may maintain a number of different pacing algorithms to control the frequency of calls being placed and thus enact different dialing strategies based on the performance of individual agents, for example, their availability and respective skill-sets, the progress of call campaigns, the number of calls placed per request, as well as, based on statistical or historical data revealing the probabilities of call results considering external factors such as time, location, etc.

Various pacing algorithms are known to those skilled in the art. For instance, predictive dialing technologies from Lucent/Avaya (formerly Mosaix) use a pacing algorithm that is based on metrics such as average agent wait time, average caller hold time, and by calculating average dropped call rates per hour. Another example of a pacing algorithm, one which Davox technology uses, is one in which metrics such as fixed lines per active agent, number of dropped calls per group or per campaign, and average agent wait time per group or per campaign are calculated. Further description of pacing algorithms may be found in Pacing Logic-88, 98, Notes from Predictive Dialing Fundamentals: An Overview of Predictive Dialing Technologies, Their Applications and Usage Today by Aleksander Szlam, Ken Thatcher; CMP Books; 2nd edition (Feb. 1, 1996). The predictive dialing of the present invention may use any one or more of the above known pacing algorithms, in one embodiment.

In another aspect, a pacing algorithm in the predictive dialing of the present invention may enable the ELC 102 to monitor, analyze, and report dialed calls, calls in progress, agent performance and utilization per group or per campaign or per call list, call campaign history, the time-zones in which calls are placed, and telephone company statistics for phone numbers such as calculating how long a phone number is in a disconnected state for non-payment, meaning how long a ‘disconnected’ operator intercept message will be triggered for a specific phone number.

The predictive dialing system and method may be used at call centers to automatically place outbound calls, for example, for telemarketing or to locate persons for skip tracing purposes. The predictive dialing system and method may be implemented on a general purpose computer. The system may include a single x86 machine running Linux with four Dialogic D/240PC1-T1 cards, utilizing CTBus™ Dialogic's circuit-switched bus.

While the invention has been described with reference to several embodiments, it will be understood by those skilled in the art that the invention is not limited to the specific forms shown and described. Thus, various changes in form and details may be made therein without departing from the spirit and scope of the invention as defined by the appended claims.

What is claimed is:

1. A method for predictive dialing, comprising:
receiving a telephone number to dial;
automatically dialing the telephone number; and
analyzing a response tone from a receiver side, including detecting whether speech is in the response tone, and determining message content of the speech if speech is detected.

2. The method of claim 1, further including:
determining one or more follow-up actions based on the analyzing.

3. The method of claim 2, wherein the one or more follow-up actions include:
determining whether the telephone number dialed is a valid number based on the analyzing of the response tone.

4. The method of claim 3, further including:
dynamically deleting the telephone number from a list of telephone numbers if the dialed telephone number is determined to be not valid.

5. The method of claim 3, wherein the telephone number is determined to be not valid, if the message content indicates that the telephone number has been disconnected.

6. The method of claim 3, wherein the telephone number is determined to be not valid, if the message content indicates that the telephone number has been changed.

7. The method of claim 1, wherein the analyzing step further includes using a statistical speech recognition model for determining the message content.

8. The method of claim 7, wherein the statistical speech recognition model includes a hidden Markov model.

9. The method of claim 1, wherein the analyzing step further includes using a plurality of speech recognition models, and the determining message content includes determining message content based on a result of a speech recognition model having a highest confidence level among the plurality of speech recognition models.

10. The method of claim 9, wherein the highest confidence level is determined as a function of one or more properties of the plurality of speech recognition models and one or more qualities of the response tone.

11. The method of claim 10, wherein the one or more properties of the plurality of speech recognition models include an ability to detect low audio quality and the one or more qualities of the response tone include a low audio quality.

12. The method of claim 9, the method further including:
determining one or more properties of the plurality of speech recognition models; and
determining one or more qualities of the response tone, to calculate the highest confidence level.

13. The method of claim 7, wherein the statistical speech recognition model includes audio data signature recognition.

14. The method of claim 7, wherein the statistical speech recognition model includes spectral analysis of voice data.

15. The method of claim 1, wherein the analyzing step further includes:
dividing the response tone into one or more sets of frequencies to separate into one or more components of sound; and
determining if a known pattern exists in the sets of frequencies.

16. The method of claim 15, further including:
computing a score based on whether a known pattern is recognized within the sets of frequencies.

17. The method of claim 1, further including:
echoing the message content, if it is determined that the message content includes a live greeting voice.

18. A system for predictive dialing, comprising:
one or more low level modules for dialing telephone numbers and receiving response signals from the dialed telephone numbers, the low level modules further recording the received response signals;
a speech recognition module for determining content of the received response signals; and
a high level module for providing the telephone numbers to the low level modules to dial, the high level module farther receiving the content of the received response signals and determining one or more actions to perform based on the content.

19. The system of claim 18, wherein the speech recognition module includes a signal processing module that divides the response tone into one or more sets of frequencies and separates components of sound from the one or more sets of frequencies to determine if one or more known patterns exist within the sets of frequencies, and computes a score based on whether one or more known patterns exist.

20. The system of claim 18, wherein the high level module and the one or more low level modules runs on multiple machines in a cluster-based computing model.

21. A program storage device readable by a machine, tangibly embodying a program of instructions executable by the machine to perform method steps of predictive dialing, comprising:
receiving a telephone number to dial;
automatically dialing the telephone number; and
analyzing a response tone from a receiver side, including detecting whether speech is in the response tone, and determining message content of the speech if speech is detected.

22. A method for predictive dialing, comprising:
receiving a list of telephone number to perform automatic dialing;
automatically dialing a telephone number in the list;
listening to a response tone from the telephone number dialed;
separating the response tone into one or more sets of frequencies;
extracting one or more sound components from the one or more sets of frequencies;
detecting a known pattern in the one or more sound components to recognize contents of the response tone; and
responding according to the recognized contents.
